(19) United States
(12) Patent Application Publication
(10) Pub. No.: US 2023/0207824 A1
(43) Pub. Date: Jun. 29, 2023

(54) LITHIUM-ION BATTERY

(71) Applicants: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(72) Inventors: Hidenori YOKOO, Kosai-shi (JP); Shotaro DEGUCHI, Toyohashi-shi (JP); Takaaki IZUMOTO, Toyohashi-shi (JP)

(73) Assignees: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(21) Appl. No.: 18/086,099

(22) Filed: Dec. 21, 2022

(30) Foreign Application Priority Data
Dec. 27, 2021 (JP) 2021-212374

(51) Int. Cl. H01M 4/62; H01M 10/0525

(52) U.S. Cl. CPC H01M 4/624; H01M 10/0525; H01M 2004/028

(57) ABSTRACT

A lithium-ion battery includes a positive electrode, which includes positive electrode mixture material containing positive electrode active material particles and conductive material, a negative electrode, which includes a negative electrode mixture material, and an electrolyte. The positive electrode active material particles include primary particles, a first particle aggregate of the primary particles cohered into a mass with a hollow portion having a diameter of less than 1 μm, and a second particle aggregate of the primary particles cohered into a mass with a hollow portion having a diameter of 1 μm or greater. When referring to the primary particles and the first particle aggregate as first particles, the first particles occupy 5% to 70% of the positive electrode active material particles. The positive electrode mixture material has a void percentage of 20% to 60%. The conductive material has an aspect ratio of 1:10 or greater.

### BACKGROUND

### 1. Field

The following description relates to a lithium-ion battery.

### 2. Description of Related Art

A lithium-ion battery is used as a power source for a battery electric vehicle. Such a battery may also be used as a power source for a hybrid electric vehicle that uses a motor and an engine as drive sources.

The positive electrode and negative electrode of such a lithium-ion battery include active material that stores and releases lithium (Li) ions in a reversible manner. The positive electrode active material particles serving as the positive electrode active material in the positive electrode contain primary particles, which are particles of the smallest unit, and particle aggregates, which are formed by the cohesion of the primary particles. When the percentage of the primary particles in the positive electrode is high, the specific surface area that affects the battery reaction increases and improves the battery performance.

Japanese Laid-Open Patent Publication No. 2000-133246 states that active material having a large specific surface area will improve the battery performance, such as the discharge capacity, but will also advance decomposition of the electrolytic solution and decomposition of by-products of the positive electrode active material, resulting in gas being generated. To limit the generation of gas from a positive electrode mixture material of primary particles and secondary particles, which are particle aggregates, the average particle diameter of the primary particles is controlled. Further, the percentage of the primary particles in the mixture material is increased. More specifically, the average particle diameter of the primary particles is set to 1.5 μm to 15 μm, and the ratio of the amount A of primary particles to the sum of the amount A of primary particles and the amount B of secondary particles “A/(A+B)” is set to 0.8 or greater.

When the ratio of the amount of primary particles is 0.8 or greater, decomposition of the electrolytic solution will not occur. This will, however, increase the density of the positive electrode mixture material containing the positive electrode active material and narrow the passage through which the electrolytic solution flows. When the passage through which the electrolyte flows is narrowed, the internal resistance of the battery will increase.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One aspect of the present disclosure is a lithium-ion battery including a positive electrode, a negative electrode, and an electrolyte. The positive electrode includes a positive electrode mixture material containing positive electrode active material particles and a conductive material. The negative electrode includes a negative electrode mixture material. The positive electrode active material particles of the positive electrode mixture material include primary particles, a first particle aggregate of the primary particles cohered into a hollow mass with a hollow portion having a diameter of less than 1 μm, and a second particle aggregate of the primary particles cohered into a hollow mass with a hollow portion having a diameter of 1 μm or greater. When referring to the primary particles and the first particle aggregate as first particles, a percentage of a total volume of the first particles with respect to a total volume of the positive electrode active material particles is 5% or greater and 70% or less. The positive electrode mixture material has a void percentage of 20% or greater and 60% or less. The conductive material has an aspect ratio of 1:10 or greater.

In the lithium-ion battery, the percentage of the volume of the first particles is 20% or greater and 50% or less.

In the lithium-ion battery, the void percentage is 30% or greater and 50% or less.

In the lithium-ion battery, the aspect ratio of the conductive material is 1:30 or greater.

In the lithium-ion battery, a content percentage of the conductive material with respect to weight of positive electrode mixture material is 0.1 wt % or greater and 5 wt % or less.

In the lithium-ion battery, the conductive material has an average diameter of 1 nm or greater and 100 nm or less.

Other features and aspects will be apparent from the following detailed description, the drawings, and the claims.

### BRIEF DESCRIPTION OF THE DRAWINGS

FIG. 1 is a schematic diagram showing an electrode body of a lithium-ion battery that is one embodiment of a non-aqueous rechargeable battery.

FIG. 2 is a schematic diagram showing the distribution of positive electrode active material particles and conductive material in the embodiment.

FIG. 3 is a chart showing the relationship of first particle percentage and void percentage with respect to battery resistance in the embodiment.

FIG. 4 is a chart showing the relationship of the first particle percentage and the void percentage with respect to the battery resistance in the prior art.

FIG. 5 is a graph showing the relationship of the first particle percentage and DC resistance when the void percentage is 30%.

FIG. 6 is a graph showing the relationship of the first particle percentage and reaction resistance when the void percentage is 30%.

FIG. 7 is a graph showing the relationship of the first particle percentage and diffusion resistance when the void percentage is 30%.

FIG. 8 is a graph showing the relationship of the first particle percentage and total resistance when the void percentage is 30%.

FIG. 9 is a graph showing the relationship of the first particle percentage and the DC resistance when the void percentage is 50%.

FIG. 10 is a graph showing the relationship of the first particle percentage and the reaction resistance when the void percentage is 50%.

FIG. 11 is a graph showing the relationship of the first particle percentage and the diffusion resistance when the void percentage is 50%.

FIG. 12 is a graph showing the relationship of the first particle percentage and the total resistance when the void percentage is 50%.

FIG. 13 is a graph showing the relationship of the void percentage and the DC resistance when the first particle percentage is 20%.

FIG. 14 is a graph showing the relationship of the void percentage and the reaction resistance when the first particle percentage is 20%.

FIG. 15 is a graph showing the relationship of the void percentage and the diffusion resistance when the first particle percentage is 20%.

FIG. 16 is a graph showing the relationship of the void percentage and the total resistance when the first particle percentage is 20%.

FIG. 17 is a graph showing the relationship of the void percentage and the DC resistance when the first particle percentage is 50%.

FIG. 18 is a graph showing the relationship of the void percentage and the reaction resistance when the first particle percentage is 50%.

FIG. 19 is a graph showing the relationship of the void percentage and the diffusion resistance when the first particle percentage is 50%.

FIG. 20 is a graph showing the relationship of the void percentage and the total resistance when the first particle percentage is 50%.

FIG. 21 is a table showing the evaluation of each resistance and the total resistance of the lithium-ion battery that includes a conductive material having an aspect ratio of 1:10 or greater on a positive electrode.

FIG. 22 is a table showing the evaluation of each resistance and the total resistance of the lithium-ion battery that includes particulate conductive material on a positive electrode.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

One embodiment of the present disclosure will now be described.

Structure of Lithium-Ion Battery

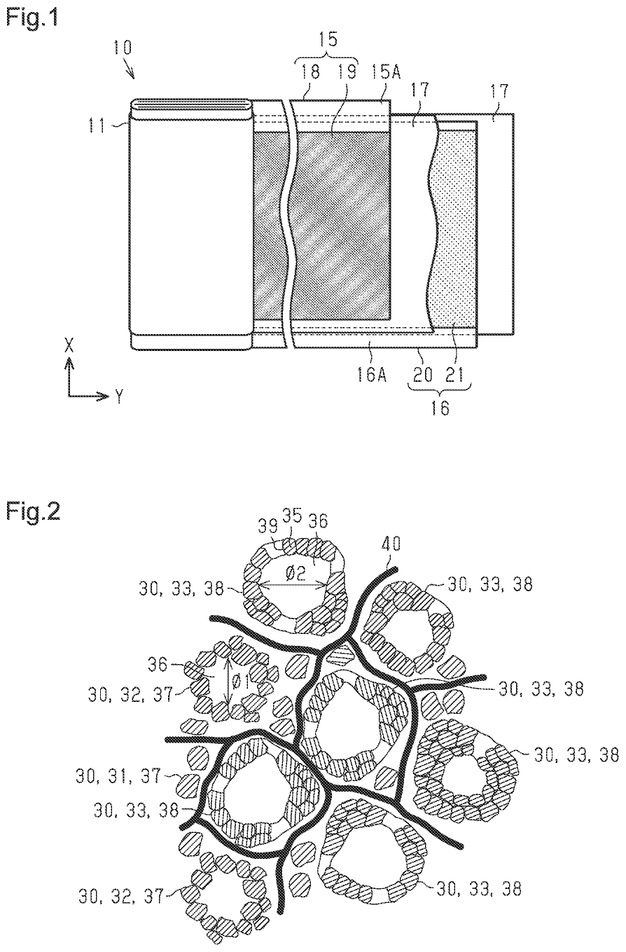

As shown in FIG. 1, a lithium-ion battery 10 includes a case (not shown), an electrode body 11, and a non-aqueous electrolyte. The electrode body 11 is a roll of sheets. The electrode body 11 is formed by rolling a stack of a positive electrode sheet 15 serving as a positive electrode plate, a negative electrode sheet 16 serving as a negative electrode plate, and separators 17. The positive electrode sheet 15 includes an elongated sheet of a positive electrode collector 18 and a positive electrode mixture material layer 19, which is applied to each of the two opposite surfaces of the positive electrode collector 18. The positive electrode mixture material layer 19 is formed by a positive electrode mixture material paste that is applied to and dried on the positive electrode collector 18. The negative electrode sheet 16 includes an elongated sheet of a negative electrode collector 20 and a negative electrode mixture material layer 21, which is applied to each of the two opposite surfaces of the negative electrode collector 20. The negative electrode mixture material layer 21 is formed in a process for applying and drying a negative electrode mixture material paste. The stack prior to rolling is formed by stacking the positive electrode sheet 15, a separator 17, the negative electrode sheet 16, and a separator 17 in this order so that longitudinal directions of the positive electrode sheet 15 and the negative electrode sheet 16 coincide. The stack is rolled so that the positive electrode sheet 15 is located at the innermost side. The longitudinal directions of the positive electrode sheet 15 and the negative electrode sheet 16 is referred to as the longitudinal direction Y, and the direction orthogonal to the longitudinal direction Y is referred to as the widthwise direction X.

The stack is rolled in the longitudinal direction Y, and the outer surface of the rolled stack is pressed so that the electrode body 11 has a flattened form. One end of the positive electrode sheet 15 in the widthwise direction X includes an uncoated portion 15A where the positive electrode mixture material layer 19 is not formed and the positive electrode collector 18 is exposed. One end of the negative electrode sheet 16 in the widthwise direction X includes an uncoated portion 16A where the negative electrode mixture material layer 21 is not formed and the negative electrode collector 20 is exposed. The lithium-ion battery 10 includes metal connectors joined with the uncoated portions 15A and 16A and electrically connected to external terminals, which are located on the outer surface of the case, to allow for the extraction of power.

The positive electrode will now be described. A metal foil such as an aluminum foil is used as the positive electrode collector 18. The positive electrode mixture material layer 19 includes a positive electrode active material, a conductive material, a binder, and the like. The positive electrode active material may be one or more types of known substances that can be used as the positive electrode active material of a lithium-ion battery. Preferred examples include layered or spinel lithium composite metal oxide (e.g., LiNiO₂, LiCoO₂, LiFeO₂, LiMn₂O₄, LiNi_{0.5}Mn_{1.5}O₄, LiCrMnO₄, or LiFePO₄). Examples of the binder include polyvinylidene fluoride (PVDF), styrene-butadiene copolymer (SBR), polytetrafluoroethylene (PTFE), or the like. The percentage of the positive electrode active material in the entire positive electrode mixture material is preferably 60 wt % or greater (typically, 60 wt % or greater and 99 wt % or less). Further, the percentage of the positive electrode active material in the entire positive electrode mixture material may be 70 wt % or greater and 99 wt % or less.

The material of the negative electrode will now be described. The negative electrode collector 20 is formed by a foil of metal such as copper or nickel. The negative electrode mixture material layer 21 includes a negative electrode active material, a conductive material, a binder, and the like. The negative electrode active material may be one or more types of known substances that can be used as the negative electrode active material of a lithium-ion battery. An example of a negative electrode active material is a carbon material, such as graphite, hard carbon, soft carbon, carbon tubes, or the like. In particular, graphite, such as natural graphite or artificial graphite, is preferred (especially, natural graphite) because it has superior conductivity and obtains high energy density. The binder may be the same as that of the positive electrode. In addition, a viscosity increasing agent, a dispersing agent, and the like may be used. The viscosity increasing agent may be, for example, carboxymethyl cellulose (CMC) or methylcellulose (MC).

Preferably, the percentage of the negative electrode active material in the entire negative electrode mixture material layer is 50 wt % or greater. The percentage of the negative electrode active material may be 90 wt % or greater and 99 wt % or less. When the binder is used, the percentage of the binder in the entire negative electrode mixture material layer 21 is, preferably, 0.5 wt % or greater and 10 wt % or less and may be 0.5 wt % or greater and 5 wt % or less. When the viscosity increasing agent is used, the percentage of the viscosity increasing agent in the entire negative electrode mixture material layer 21 is, preferably, 0.5 wt % or greater and 10 wt % or less and may be 0.5 wt % or greater and 5 wt % or less.

The separator 17 includes a porous layer formed from resin. The porous layer is, for example, a single-layer structure of porous polyethylene, porous polyolefin, porous polyvinyl chloride, or the like. Alternatively, the porous layer is a multi-layer structure of a plurality of materials. The porous layer may include a filler to increase strength. An adhesive layer formed from an adhesive agent may be arranged between the separator 17 and the negative electrode sheet 16.

The non-aqueous electrolyte is a composition containing support salt in a non-aqueous liquid solvent. The non-aqueous solvent may be one or more of propylene carbonate (PC), ethylene carbonate (EC), diethyl carbonate (DEC), dimethyl carbonate (DMC), ethyl methyl carbonate (EMC), and the like. The support salt may be a lithium compound (lithium salt) of one or two or more selected from the group consisting of LiPF₆, LiBF₄, LiClO₄, LiAsF₆, LiCF₃SO₃, LiC₄F₉SO₃, LiN(CF₃SO₂)₂, LiC(CF₃SO₂)₃, LiI, and the like.

Positive Electrode Mixture Material

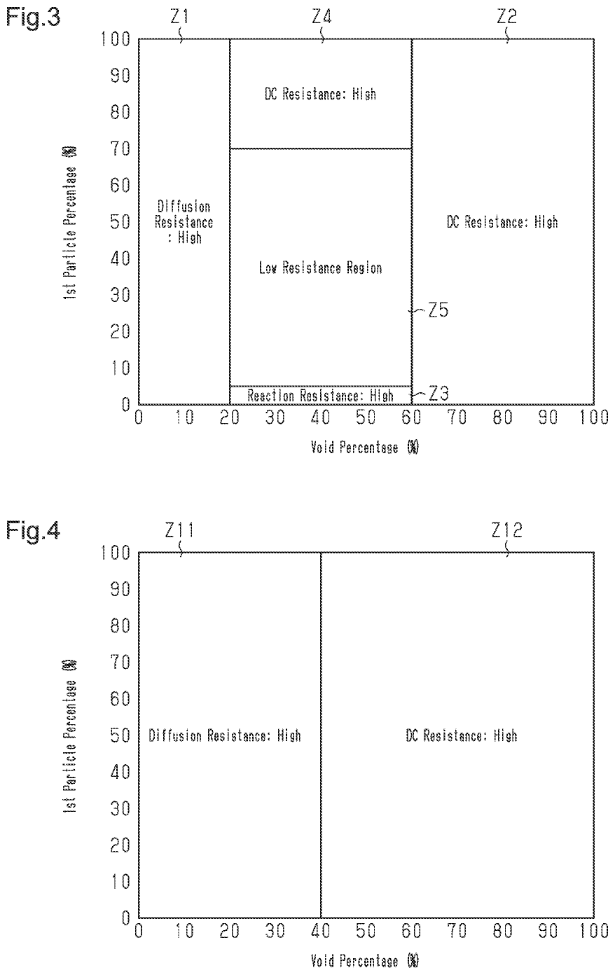

The positive electrode mixture material will now be described with reference to FIGS. 2 and 3.

FIG. 2 is a schematic cross-sectional view of the positive electrode active material particles 30. The positive electrode active material particles 30 include primary particles 31, first particle aggregates 32, and second particle aggregates 33. The primary particles 31 are the smallest particle units and cannot be divided further finely. The first particle aggregates 32 and the second particle aggregates 33 are formed by hollow masses of cohered primary particles 31. During a process for forming the positive electrode active material particles 30, the primary particles 31 cohere and form the first particle aggregates 32 and the second particle aggregates 33. The second particle aggregates 33 crack and deform during the production of the positive electrode mixture material and form the primary particles 31 and the first particle aggregates 32. In this manner, cracking and deformation of a second particle aggregate 33 will cause separation of some of the cohered primary particles 31. This moves the primary particles 31 of a particle aggregate away from one another.

The first particle aggregates 32 and the second particle aggregates 33 have a larger particle diameter than the primary particles 31. The first particle aggregates 32 and the second particle aggregates 33 each include a shell 35. A hollow portion 36 is formed in the shell 35. The shell 35 may include a through hole 39 that extends through the shell 35. There may be one or more through holes 39.

The first particle aggregates 32 differ from the second particle aggregates 33 in the diameter of the hollow portion 36. In other words, the first particle aggregates 32 differ from the second particle aggregates 33 in the inner diameter of the shell 35. The first particle aggregates 32 each have a diameter φ1 of less than 1 μm. The diameter of the hollow portion 36 is where the length is relatively the greatest between the primary particles 31 forming the first particle aggregate 32 and defining the hollow portion 36. The diameter is not measured at a portion where the through hole 39 is located. The second particle aggregates 33 each have a diameter φ2 of 1 μm or greater. Cracking of the shell 35 and separation of the primary particles 31 result in the hollow portion 36 of the first particle aggregate 32 having a small inner diameter φ2.

The first particle aggregates 32 and the second particle aggregates 33 are distinguished in accordance with the diameter of the hollow portion 36. In any case, the second particle aggregates 33 have a relatively larger average diameter than the first particle aggregates 32. More specifically, the first particle aggregates 32 have an average particle diameter of 0.1 μm or greater and 10 μm or less. The second particle aggregates 33 have an average particle diameter of 2 μm or greater and 10 μm or less. The average particle diameter of the positive electrode active material particles 30 is a 50%-integrated value measured through a laser diffraction particle size distribution measurement method using the Mie scattering theory.

Although the second particle aggregates 33 have a smaller specific surface area than the first particle aggregates 32, the primary particles 31 cohered in a densely collected manner decrease the direct current (DC) resistance. The inventors of the present invention have found that the percentage of the second particle aggregates 33 in the positive electrode active material particles 30 affects the internal resistance of the lithium-ion battery 10. In the description hereafter, the primary particles 31 and the first particle aggregates 32 will be referred to as the first particles 37 and distinguished from the second particle aggregates 33 that will be referred to as the second particles 38.

The positive electrode mixture material forming the positive electrode mixture material layer 19 satisfies conditions 1 to 3 that are described below. It is further preferable that the positive electrode mixture material satisfy at least one of conditions 4 and 5.

Percentage of First Particles

The percentage of the volume of the first particles 37 with respect to the total volume of the positive electrode active material particles is 5% or greater and 70% or less (condition 1). Preferably, the percentage of the volume of the first particles 37 is 20% or greater and 50% or less. The percentage of the first particles 37 is calculated based on a positive electrode sheet 15 of a lithium-ion battery 10 that is ready to be shipped out of the factory. When forming the positive electrode sheet 15, the positive electrode mixture material layer 19 is pressed to crush some of the second particle aggregates 33 into the first particles 37. Further, some of the second particle aggregates 33 are deformed or crushed into the first particle aggregates 32. When forming the positive electrode mixture material paste, most of the positive electrode active material particles 30, which are mixed with the conductive material, dispersion medium, and the like, are in the state of the second particle aggregates 33. The percentage of the first particles 37 can be adjusted in accordance with the selected positive electrode active material by controlling the pressure applied during the pressing process. The percentage of the first particles 37 can be measured through a method using, for example, a scanning electron microscope. Such a method emits an ion beam onto the positive electrode mixture material layer 19 to expose a cross section in the same manner as when measuring the void percentage. Further, the image of the entire cross section of the positive electrode mixture material layer 19 is captured with the scanning electron microscope. The first particles 37 are distinguished from the second particles 38 in the cross-sectional image to obtain the area occupied by the first particles 37 and the area occupied by the second particles 38. The ratio of the area occupied by the first particles 37 and the area occupied by the second particles 38 in the cross section is substantially the same as the ratio of the volume of the first particles 37 and the volume of the second particles 38 per unit volume of the positive electrode mixture layer. The ratio of the area occupied by the first particles 37 to the sum of the occupied areas is obtained. An ion beam is emitted repetitively (e.g. ten times) onto the positive electrode mixture material layer 19 to further expose new cross sections. The cross-sectional images are used to calculate the ratio of the area occupied by the first particles 37. The average ratio of the area occupied by the first particles 37 was expressed as the percentage (%) of the first particles 37.

In a process for forming the positive electrode mixture layer paste by kneading a positive electrode active material, a conductive material, and a binder with a dispersion medium, it is preferred that the positive electrode active material particles 30 be maintained in the state of the second particles 38. This is because the cohesion force acting between the first particles 37 in the positive electrode mixture material paste will cause the viscosity of the paste to become excessive when the content percentage of the first particles 37 in the positive electrode active material particles 30 is 5% or greater. Such an increase in the viscosity of the paste caused by the cohesion force of the first particles 37 will result in more solvent being necessary, which, in turn, will increase the manufacturing cost. Further, the first particles 37 will cause the size per unit weight to be enlarged, which, in turn, will increase the transportation cost.

Void Percentage

The positive electrode mixture material layer 19 has a void percentage of 20% or greater and 60% or less (condition 2). Preferably, the void percentage is 30% or greater and 50% or less. The void percentage is the percentage of the volume of voids that are not filled with positive electrode active material particles, conductive material, or binder in the positive electrode mixture material layer 19. The volume of voids includes the volume of the hollow portions 36 and the through holes 39 in the first particle aggregates 32 and the second particle aggregates 33. The void percentage can be adjusted by the pressure applied on the positive electrode mixture material layer 19 in the pressing process when forming the positive electrode sheet 15. The method for measuring the void percentage is not particularly limited. For example, the void percentage may be calculated by subtracting the positive electrode mixture material volume from the unit space volume. The positive electrode mixture material volume can be calculated from the weight, thickness, and composition ratio of the positive electrode mixture material and the true density of each material. The true density of each material can be measured in compliance with, for example, JIS K 0061:2001, Test Methods for Density and Relative Density of Chemical Products.

The second particles 38 of the shells 35 that are relatively thinner and crack more easily become the first particles 37. The thickness of the shell 35 can be estimated from the oil absorption. Preferably, the oil absorption of the second particles 38 is 20 ml/100 g or greater. Preferably, the oil absorption is 20 ml/100 g or greater and 60 ml/100 g or less in order for the percentage of the first particles 37 to be 5% or greater and 70% or less and the void percentage to be in the range described subsequent to the pressing performed when forming the positive electrode sheet. The oil absorption amount as referred to here is the amount of refined linseed oil absorbed by the second particles 38 under fixed conditions and is measured in compliance with JIS K 5101-13-1, Part 13: Oil Absorption, Section 1: Refined Linseed Oil Method. Oil is absorbed by the second particles 38 into the hollow portion 36. A greater oil absorption will indicate that the hollow portion 36 is large and the shell 35 is thin.

Conductive Material

The conductive material 40 is long and thin. The conductive material 40 is carbon material. The conductive material 40 may be, for example, a carbon material that is at least any one of various types of carbon black (e.g., acetylene black, ketjen black), coke, active carbon, graphite, carbon fibers (PAN-based carbon fibers, pitch-based carbon fibers), carbon nanotubes, and the like.

The conductive material 40 has an aspect ratio of 1:10 or greater (condition 3). Preferably, the aspect ratio of the conductive material 40 is 1:30 or greater. The aspect ratio is the ratio of the shorter side to the longer side in the conductive material 40. When tubular carbon nanotubes are the conductive material 40, the aspect ratio is the ratio of the diameter of the tube to the height, or length, of the tube. When the aspect ratio of the conductive material 40 is 1:10 or greater, for example, 1:50 or 1:100, the conductive material 40 is interposed in slight gaps between the positive electrode active material particles 30 to contact with the positive electrode active material particles 30 and a conductive network will be constructed between the positive electrode active material particles 30. When the aspect ratio of the conductive material 40 is less than 1:10, for example, 1:5, it will be difficult to construct a conductive network between the positive electrode active material particles 30.

Preferably, when condition 3 of the aspect ratio is satisfied, the average diameter of the conductive material 40 is 100 nm or less (condition 4). This is because gaps are formed between the positive electrode active material particles 30, and it is thus desirable that the conductive material 40 bridge the positive electrode active material particles 30. It becomes difficult to construct a conductive network when the average diameter of the conductive material 40 exceeds 100 nm.

In addition, the average diameter of the conductive material 40 is, preferably, 1 nm or greater. When the average diameter of the conductive material 40 is less than 1 nm, the cohesion force of the conductive material 40 increases. Thus, the conductive material 40 coheres and dispersion becomes limited. Further, the average diameter of the conductive material 40 is 5 nm or greater and 50 nm or less. The method for measuring the average diameter of the conductive material 40 is not particularly limited. For example, a predetermined amount, such as 20 tubes, of the conductive material 40 is selected from an image obtained by, for example, a transmission electron microscope to measure the diameter and calculate the average diameter.

In addition, when condition 3 of the aspect ratio is satisfied, the average length of the conductive material 40 is, preferably, 100 nm to 10000 nm (10 μm). When the average length of the conductive material 40 is less than 100 nm, it becomes difficult to form a conductive network between the positive electrode active material particles. When the average length becomes greater than 10000 nm, dispersion becomes limited and manufacture is adversely affected.

Preferably, the percentage of the conductive material 40 with respect to the weight of the positive electrode mixture layer is 0.1 wt % or greater and 5 wt % or less (condition 5). When the percentage of the conductive material 40 is less than 0.1 wt %, the conductivity of the positive electrode mixture material decreases, and the internal resistance increases. When the percentage of the conductive material 40 is greater than 5 wt %, the percentage of the positive electrode active material decreases, and the battery capacity increases. Further, the gap percentage becomes small. This reduces, narrows, and lengthens the passage for electrolyte. Thus, the diffusion resistance of the electrolyte increases. Moreover, the percentage of the binder becomes small. This decreases the adhesion of the positive electrode mixture material layer 19 and the positive electrode collector 18.

In the present embodiment, carbon nanotubes are used as the conductive material 40. Carbon nanotubes are fibers of conductive material. Carbon nanotubes form a six-membered ring network (graphene sheet) of carbon and have a monolayer or multilayer structure. Carbon nanotubes are tubular, have high strength, and are thermally stable. Further, carbon nanotubes have superior electrical conductance, thermal conductance, and heat resistance. In the present embodiment, the carbon nanotubes are not limited in shape and thus may be monolayered or multilayered and have open ends or closed ends. When adding the conductive material 40 of carbon nanotubes, electrical conductance can be obtained even with a material that is not supposed to conduct electricity such as the binder. The carbon nanotubes are flexible and do not break even when bending stress is applied. Thus, the carbon nanotubes deform in conformance with the shape of the gaps between the positive electrode active material particles 30 and come into contact with particles in an entangled manner.

Internal Resistance of Battery

The internal resistance of the lithium-ion battery 10 will now be described. Each component of the internal resistance of the lithium-ion battery 10 can be measured through an AC impedance method. The AC impedance method applies voltage or current to the electrodes of the lithium-ion battery 10 at an infinitesimal amplitude while changing the frequency in a stepped manner to observe an impedance spectrum. The alternating current may be a sine wave, rectangular wave alternating current, triangular wave alternating current, or sawtooth wave alternating current. The analysis results of the lithium-ion battery 10 obtained through the AC impedance method are output as, for example, Nyquist plots. A Nyquist plot is a graph plotting, in a two-dimensional manner, imaginary values Zi and real values Zr when applying voltage or current while changing the frequency in steps. Information related to the DC resistance, reaction resistance, and diffusion resistance of the lithium-ion battery 10 can be obtained from Nyquist plots.

The DC resistance is also referred to as the electron transfer resistance and expressed by the real value Zr. The DC resistance is the resistance produced when electrons are transferred in the electrolyte, the electrode mixture material, the collector, and the like. When the percentage of voids increases in the positive electrode mixture material layer 19, the DC resistance increases. Further, when a conductive network is appropriately constructed by the conductive material 40, the DC resistance decreases.

The reaction resistance is a resistance measured at a frequency between, for example, 100 Hz and 0.1 Hz. The reaction resistance is the resistance produced by the reaction of electrons transferred in the surface of the active material. The reaction resistance decreases as the surface area of the positive electrode active material particles 30 increases. The surface area of the positive electrode active material particles 30 increases as the percentage of the first particles 37 increases.

The diffusion resistance is measured at, for example, a low frequency of less than 0.1 Hz. The diffusion resistance is the resistance produced when ions are diffused in the electrolyte. When using a non-aqueous electrolyte that has flowability, if the density of the positive electrode active material particles 30 decreases, a passage for movement of the non-aqueous electrolyte will be obtained between the positive electrode active material particles 30. Thus, when the density of the positive electrode mixture material layer 19 decreases, the diffusion resistance will decrease.

With reference to FIGS. 3 and 4, the relationship of the percentage of the first particles 37 and the void resistance with respect to each resistance component will now be described. FIG. 3 shows ranges of resistance components, namely, regions Z1 to Z5, set by threshold values of the resistance components, and the relationship of the percentage of the first particles 37 and the void percentage. More specifically, upper limit values are provided for the DC resistance, the reaction resistance, and the diffusion resistance to specify regions Z1 to Z4 for when the upper limit values are exceeded as the percentage of the first particles 37 and the void percentage change. Carbon nanotubes are used as the conductive material 40 at the positive electrode of the lithium-ion battery 10. In region Z1 where the void percentage of the positive electrode mixture material layer 19 is 0% or greater and less than 20%, the passage for movement of ions is reduced in size or closed. As a result, the diffusion resistance is excessively high. In region Z2 where the void percentage of the positive electrode mixture material layer 19 is greater than 60% and 100% or less, the diffusion resistance decreases. However, the conductive network is broken by voids. Thus, the DC resistance is excessively high.

In the region between the regions Z1 and Z2 where the percentage of the first particles 37 in the positive electrode mixture material layer 19 is too small, that is, in region Z3 where the percentage of the first particles 37 is less than 5%, the specific surface area is small Thus, the reaction resistance is excessively high. In region Z4 where the percentage of the first particles 37 in the positive electrode mixture material layer 19 is greater than 70%, the primary particles 31 are cohered densely, and the amount of second particles 38 that decrease the DC resistance is small. Thus, the DC resistance of the positive electrode mixture material layer 19 is excessively high.

In this manner, the DC resistance is a tradeoff for the reaction resistance and diffusion resistance. Thus, if one resistance component falls, the other resistance component rises. To improve the battery characteristics, it is desirable that the reaction speed in the rate-limiting step of the battery reaction be maximized and the resistance components be decreased in a balanced manner. To decrease the resistance components, the void percentage and the percentage of the first particles 37 have to be controlled. In region Z5 where each resistance component is low and the total resistance is low, the void percentage is 20% or greater and 60% or less, and the percentage of the first particles 37 is 5% or greater and 70% or less.

FIG. 4 is a map showing the percentage of the first particles 37 and the void resistance with respect to each resistance component when the lithium-ion battery 10 includes acetylene black as the conductive material 40. The map of FIG. 4 shows the characteristics of the lithium-ion battery 10 and is based on the same conditions as the map of FIG. 3 except for the conductive material 40. The aspect ratio of acetylene black is less than 1:10 and the length in the longitudinal direction is 20 to 90 nm. The use of elongated carbon nanotubes obtains electrical conductance even if the percentage of the conductive material 40 is 0.1 wt % or greater and 5 wt % or less and small. When acetylene black is the conductive material, the percentage of the conductive material has to be 5 wt % to 20 wt % to obtain electrical conductance. When acetylene black is added at this percentage, the void percentage becomes small and the passage for electrolyte is reduced. This increases the diffusion resistance of the electrolyte. Accordingly, the diffusion resistance is excessively high in region Z11 where the void percentage is less than 40%. Region Z11 of FIG. 4 is wider than region Z1 of FIG. 3, which is where the diffusion resistance is excessively high. When the void percentage is large, acetylene black contacts the positive electrode active material particles 30 at fewer points than carbon nanotubes. Thus, the DC resistance increases in region Z12 where the void percentage is 40% or greater. Region Z12 of FIG. 4 is wider than region Z2 of FIG. 3, which is where the DC resistance is excessive.

Regions Z11 and Z12 cover a wide range and thus preferred ranges like regions Z3 to Z5 shown in FIG. 3 could not be confirmed. Elongation of the conductive material 40 so that the aspect ratio is 1:10 or greater will form or widen region Z5 where the total resistance is low.

The above embodiment has the advantages described below.

(1) In the above embodiment, the percentage of the total volume of the first particles 37 with respect to the total volume of the positive electrode active material particles 30 is 5% or greater and 70% or less. Thus, in contrast with when the positive electrode active material particles 30 are all second particles 38, the specific surface area of the positive electrode active material particles 30 can be increased. This decreases the reaction resistance of the lithium-ion battery 10. Further, in contrast with when the positive electrode active material particles 30 are all first particles 37, passage for the flow of electrolyte can be obtained. The void percentage is 20% or greater and 60% or less. Thus, the DC resistance and the diffusion resistance of the lithium-ion battery 10 can be decreased. The conductive material 40 is elongated and has an aspect ratio of 1:10. Thus, the conductive material 40 can be arranged in the narrow gaps between the positive electrode active material particles 30. This allows the conductive material 40 to construct a meshed conductive network and decrease the DC resistance. In this manner, the DC resistance, the reaction resistance, and the diffusion resistance are decreased to decrease the total resistance of the lithium-ion battery 10.

(2) When the percentage of the volume of the first particles 37 is 20% or greater and 50% or less, the reaction resistance can be further decreased.

(3) When the void percentage is 30% or greater and 50% or less, the DC resistance and the diffusion resistance can be further decreased.

(4) When the aspect ratio of the conductive material 40 is 1:30 or greater, a dense conductive network can be constructed. This further decreases the DC resistance of the lithium-ion battery 10.

(5) Preferably, the content percentage of the conductive material 40 with respect to the weight of the positive electrode mixture material is 0.1 wt % or greater and 5 wt % or less. This allows a dense conductive network to be constructed and further decreases the DC resistance.

(6) With the lithium-ion battery 10, when the average diameter of the conductive material 40 is 1 nm or greater and 100 nm or less, a dense conductive network can be constructed. This further decreases the DC resistance.

### OTHER EMBODIMENTS

The above-described embodiment may be modified as described below. The above-described embodiment and the modified examples described below may be combined as long as there is no technical contradiction.

The electrode body 11 is not limited to the electrode structure that rolls the positive electrode sheet 15 and the negative electrode sheet 16 with the separator 17 arranged in between and may be changed in accordance with the shape and purpose of use of the lithium-ion battery 10. For example, the electrode structure may be of a type that does not roll and only stacks the positive electrode sheet 15 and the negative electrode sheet 16 with the separator 17 arranged in between.

The lithium-ion battery 10 may be used for an application other than the drive source of a battery electric vehicle or the drive source of a hybrid electric vehicle. For example, the lithium-ion battery 10 may be mounted on a vehicle such as a gasoline engine vehicle or a diesel engine vehicle. Further, the lithium-ion battery 10 may be used as a power source for a mobile subject such as a train, a marine vessel, or an airplane. The lithium-ion battery 10 may also be used as a power source for a robot or an electrical product such as an information processor.

### EXAMPLES

Test of Percentage of First Particles and Void Percentage

The examples and comparative examples of the lithium-ion battery 10 will now be described. The examples and comparative examples are not intended to limit the present invention.

In the description hereafter, lithium-ion batteries 10 of examples and comparative examples having the same void percentage but differing in first particle percentage were prepared and lithium-ion batteries 10 of examples and comparative examples having the same first particle percentage but differing in void percentage were prepared. The DC resistance, the reaction resistance, the diffusion resistance, and the total resistance were evaluated for each example and comparative example.

Void Percentage 30%

In examples 1 to 5 and comparative examples 1 and 2, the void percentage of the positive electrode mixture material was fixed and the first particle percentage was changed as shown below in table 1.

TABLE 1

| | 1st Particle | Void | DC | Reaction | Diffusion | Total |
|---|---|---|---|---|---|---|
| | Percentage | Percentage | Resistance | Resistance | Resistance | Resistance |
| | (wt %) | (%) | (mΩ) | (mΩ) | (mΩ) | (mΩ) |
| Example 1 | 70 | 30 | 149 | 25 | 298 | 472 |
| Example 2 | 50 | 30 | 142 | 26 | 289 | 457 |
| Example 3 | 20 | 30 | 144 | 25 | 287 | 456 |
| Example 4 | 10 | 30 | 143 | 35 | 288 | 466 |
| Example 5 | 5 | 30 | 142 | 45 | 286 | 473 |
| Comparative | 100 | 30 | 220 | 21 | 318 | 559 |
| Example 1 | | | | | | |
| Comparative | 0 | 30 | 142 | 70 | 286 | 448 |
| Example 2 | | | | | | |

### Example 1

The positive electrode active material was lithium nickel manganese cobalt oxide (LiNi_{1/3}Co_{1/3}Mn_{1/3}O₂). Most of the positive electrode active material was the second particles. A dispersion medium of N-methyl-2-pyrrolidone (NMP) was added to a mixture of positive electrode active material 98 wt %, conductive material 1 wt %, and binder 1 wt %, which was kneaded to a predetermined viscosity in order to obtain the positive electrode mixture material paste. Most of the positive electrode active material in the positive electrode mixture material paste was maintained in the state of the second particles. The conductive material was carbon nanotubes. The carbon nanotubes had an average diameter of 10 nm, an average length of 1000 nm, and an aspect ratio of 1:100. The positive electrode mixture material paste was applied to the two opposite surfaces of the positive electrode collector, formed by an aluminum foil, and then dried. Rolling was performed with pressing rolls on the dried positive electrode sheet. The pressure applied by the pressing rolls and the gap between the pressing rolls during the roll-pressing was controlled to crush the second particles to obtain the first particle percentage of 70% and the void percentage of 30%.

Further, a negative electrode active material of natural graphite powder, styrene-butadiene rubber (SBR), and carboxymethyl cellulose (CMC) was dispersed in water and kneaded. The negative electrode mixture material was applied to the two opposite surfaces of an elongated copper foil to form the negative electrode sheet. After drying the negative electrode mixture material, the negative electrode active material was pressed.

The positive electrode sheet, the negative electrode sheet, and separators were stacked to form a laminated lithium-ion battery 10 using a non-aqueous electrolyte.

### Example 2

A positive electrode sheet was formed in the same manner as in example 1 except in that the first particle percentage was 50%.

### Example 3

A positive electrode sheet was formed in the same manner as in example 1 except in that the first particle percentage was 20%.

### Example 4

A positive electrode sheet was formed in the same manner as in example 1 except in that the first particle percentage was 10%.

### Example 5

A positive electrode sheet was formed in the same manner as in example 1 except in that the first particle percentage was 5%.

### Comparative Example 1

A positive electrode sheet was formed in the same manner as in example 1 except in that the first particle percentage was 100%.

### Comparative Example 2

A positive electrode sheet was formed in the same manner as in example 1 except in that the first particle percentage was 0%.

Void Percentage 50%

In examples 6 to 10 and comparative examples 3 and 4, the void percentage was 50%, and the first particle percentage was changed as shown in table 2.

TABLE 2

| | 1st Particle | Void | DC | Reaction | Diffusion | Total |
|---|---|---|---|---|---|---|
| | Percentage | Percentage | Resistance | Resistance | Resistance | Resistance |
| | (wt %) | (%) | (mΩ) | (mΩ) | (mΩ) | (mΩ) |
| Example 6 | 70 | 50 | 155 | 24 | 290 | 469 |
| Example 7 | 50 | 50 | 149 | 26 | 276 | 451 |
| Example 8 | 20 | 50 | 146 | 25 | 273 | 444 |
| Example 9 | 10 | 50 | 148 | 39 | 274 | 461 |
| Example 10 | 5 | 50 | 145 | 44 | 273 | 462 |
| Comparative | 100 | 50 | 245 | 22 | 309 | 576 |
| Example 3 | | | | | | |
| Comparative | 0 | 50 | 145 | 73 | 273 | 491 |
| Example 4 | | | | | | |

### Example 6

A positive electrode sheet was formed in the same manner as in example 1 except in that the void percentage was 50% and the first particle percentage was 70%.

### Example 7

A positive electrode sheet was formed in the same manner as in example 1 except in that the void percentage was 50% and the first particle percentage was 50%.

### Example 8

A positive electrode sheet was formed in the same manner as in example 1 except in that the void percentage was 50% and the first particle percentage was 20%.

### Example 9

A positive electrode sheet was formed in the same manner as in example 1 except in that the void percentage was 50% and the first particle percentage was 10%.

### Example 10

A positive electrode sheet was formed in the same manner as in example 1 except in that the void percentage was 50% and the first particle percentage was 5%.

### Comparative Example 3

A positive electrode sheet was formed in the same manner as in example 1 except in that the void percentage was 50% and the first particle percentage was 100%.

### Comparative Example 4

A positive electrode sheet was formed in the same manner as in example 1 except in that the void percentage was 50% and the first particle percentage was 0%.

First Particle Percentage 20%

In examples 11 to 16 and comparative examples 5 to 7, the first particle percentage was 20%, and the void percentage was changed as shown in table 3.

TABLE 3

| | 1st Particle | Void | DC | Reaction | Diffusion | Total |
|---|---|---|---|---|---|---|
| | Percentage | Percentage | Resistance | Resistance | Resistance | Resistance |
| | (wt %) | (%) | (mΩ) | (mΩ) | (mΩ) | (mΩ) |
| Example 11 | 20 | 20 | 141 | 25 | 300 | 466 |
| Example 12 | 20 | 30 | 143 | 25 | 283 | 451 |
| Example 13 | 20 | 39 | 144 | 25 | 283 | 452 |
| Example 14 | 20 | 48 | 145 | 25 | 280 | 450 |
| Example 15 | 20 | 52 | 152 | 25 | 279 | 456 |
| Example 16 | 20 | 56 | 159 | 25 | 281 | 465 |
| Comparative | 20 | 13 | 141 | 25 | 340 | 506 |
| Example 5 | | | | | | |
| Comparative | 20 | 61 | 172 | 25 | 279 | 476 |
| Example 6 | | | | | | |
| Comparative | 20 | 67 | 205 | 25 | 280 | 510 |
| Example 7 | | | | | | |

### Example 11

A positive electrode sheet was formed in the same manner as in example 1 except in that the first particle percentage was 20% and the void percentage was 20%.

### Example 12

A positive electrode sheet was formed in the same manner as in example 1 except in that the first particle percentage was 20% and the void percentage was 30%.

### Example 13

A positive electrode sheet was formed in the same manner as in example 1 except in that the first particle percentage was 20% and the void percentage was 39%.

### Example 14

A positive electrode sheet was formed in the same manner as in example 1 except in that the first particle percentage was 20% and the void percentage was 48%.

### Example 15

A positive electrode sheet was formed in the same manner as in example 1 except in that the first particle percentage was 20% and the void percentage was 52%.

### Example 16

A positive electrode sheet was formed in the same manner as in example 1 except in that the first particle percentage was 20% and the void percentage was 56%.

### Comparative Example 5

A positive electrode sheet was formed in the same manner as in example 1 except in that the first particle percentage was 20% and the void percentage was 13%.

### Comparative Example 6

A positive electrode sheet was formed in the same manner as in example 1 except in that the first particle percentage was 20% and the void percentage was 61%.

### Comparative Example 7

A positive electrode sheet was formed in the same manner as in example 1 except in that the first particle percentage was 20% and the void percentage was 67%.

First Particle Percentage 50%

In examples 17 to 22 and comparative examples 8 to 10, the first particle percentage was 50%, and the void percentage was changed as shown in table 4.

TABLE 4

| | 1st Particle | Void | DC | Reaction | Diffusion | Total |
|---|---|---|---|---|---|---|
| | Percentage | Percentage | Resistance | Resistance | Resistance | Resistance |
| | (wt %) | (%) | (mΩ) | (mΩ) | (mΩ) | (mΩ) |
| Example 17 | 50 | 20 | 140 | 26 | 305 | 471 |
| Example 18 | 50 | 30 | 144 | 26 | 288 | 458 |
| Example 19 | 50 | 39 | 144 | 26 | 287 | 457 |
| Example 20 | 50 | 48 | 145 | 26 | 285 | 456 |
| Example 21 | 50 | 52 | 150 | 26 | 283 | 459 |
| Example 22 | 50 | 56 | 161 | 26 | 285 | 472 |
| Comparative | 50 | 13 | 142 | 26 | 345 | 513 |
| Example 8 | | | | | | |
| Comparative | 50 | 61 | 172 | 26 | 283 | 481 |
| Example 9 | | | | | | |
| Comparative | 50 | 67 | 207 | 26 | 284 | 517 |
| Example 10 | | | | | | |

### Example 17

A positive electrode sheet was formed in the same manner as in example 1 except in that the first particle percentage was 50% and the void percentage was 20%.

### Example 18

A positive electrode sheet was formed in the same manner as in example 1 except in that the first particle percentage was 50% and the void percentage was 30%.

### Example 19

A positive electrode sheet was formed in the same manner as in example 1 except in that the first particle percentage was 50% and the void percentage was 39%.

### Example 20

A positive electrode sheet was formed in the same manner as in example 1 except in that the first particle percentage was 50% and the void percentage was 48%.

### Example 21

A positive electrode sheet was formed in the same manner as in example 1 except in that the first particle percentage was 50% and the void percentage was 52%.

### Example 22

A positive electrode sheet was formed in the same manner as in example 1 except in that the first particle percentage was 50% and the void percentage was 56%.

### Comparative Example 8

A positive electrode sheet was formed in the same manner as in example 1 except in that the first particle percentage was 50% and the void percentage was 13%.

### Comparative Example 9

A positive electrode sheet was formed in the same manner as in example 1 except in that the first particle percentage was 50% and the void percentage was 61%.

### Comparative Example 10

A positive electrode sheet was formed in the same manner as in example 1 except in that the first particle percentage was 50% and the void percentage was 67%.

### Evaluation 1

Complex impedance measurement was conducted to evaluate the DC resistance, the reaction resistance, and the diffusion resistance for each example and comparative example. The measurement device includes an AC voltage generator that generates an AC voltage, a voltage application unit, and an impedance measurement unit. The frequency was changed in a stepped manner from 0.001 Hz to 100000 Hz while applying AC voltage. Nyquist plots were output to obtain the DC resistance, the reaction resistance, and the diffusion resistance. Tables 1 to 4 show the values of each resistance component.

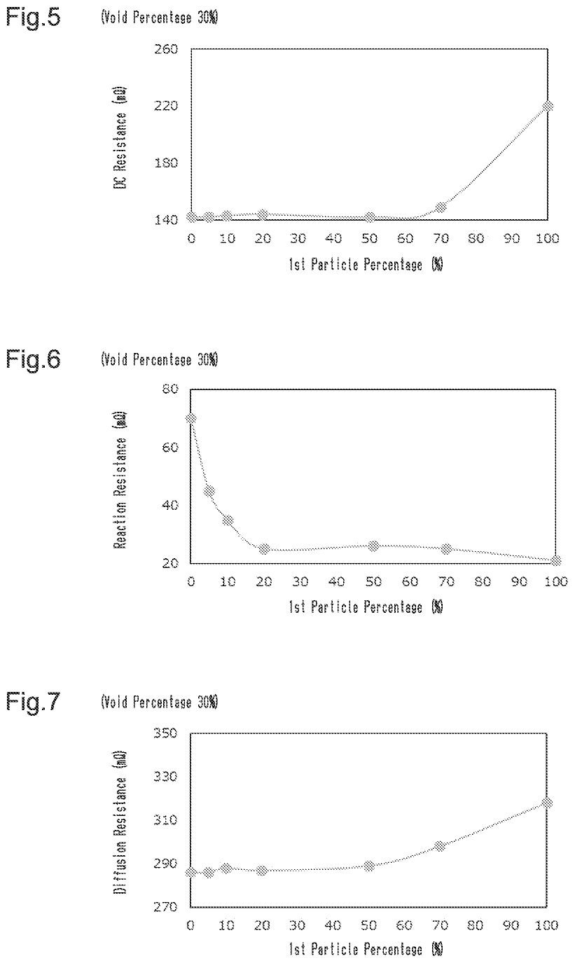

FIGS. 5 to 7 show graphs plotting the values of the DC resistance, the reaction resistance, and the diffusion resistance for examples 1 to 5 and comparative examples 1 and 2. The DC resistance increased suddenly when the first particle percentage exceeded 70%. The reaction resistance increased as the first particle percentage decreased when the first particle percentage was less than 20%. More specifically, the reaction resistance increased suddenly when the first particle percentage was less than 5% and increased gradually when the first particle percentage was 5% or greater and less than 20%. The diffusion resistance gradually increased when the first particle percentage was greater than 50% and less than 70% and increased suddenly when the first particle percentage was 70% or greater.

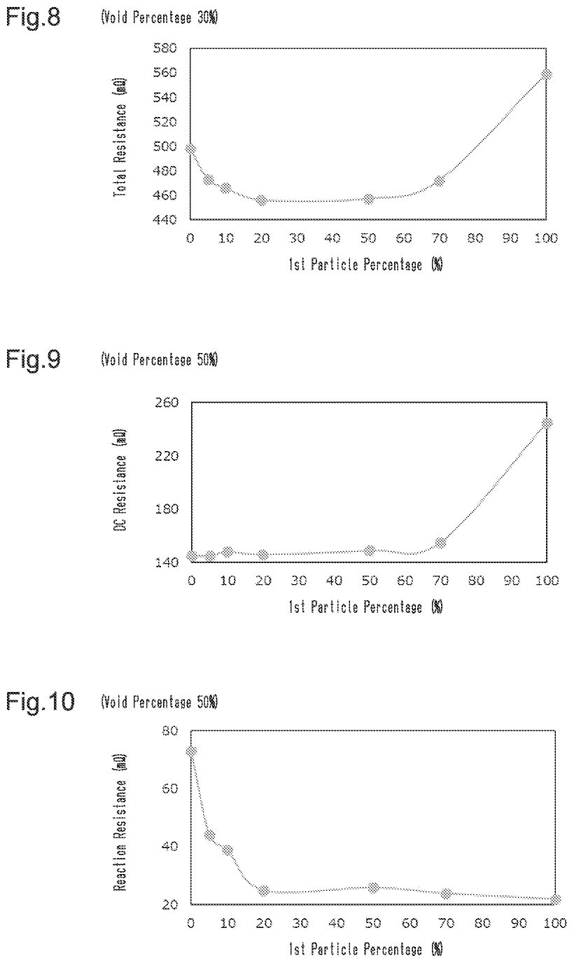

FIG. 8 shows a graph plotting the values of the total resistance for examples 1 to 5 and comparative examples 1 and 2. The total resistance exceeded 490 mΩ when the first particle percentage was less than 5% and the first particle percentage was greater than 70% and 100% or less. The total resistance was from 466 mΩ to 473 mΩ, inclusive, and relatively low when the first particle percentage was 5% or greater and less than 20% and when the first particle percentage was greater than 50% and 70% or less. The total resistance was the lowest at 456 mΩ and 457 mΩ when the first particle percentage was 20% or greater and 50% or less.

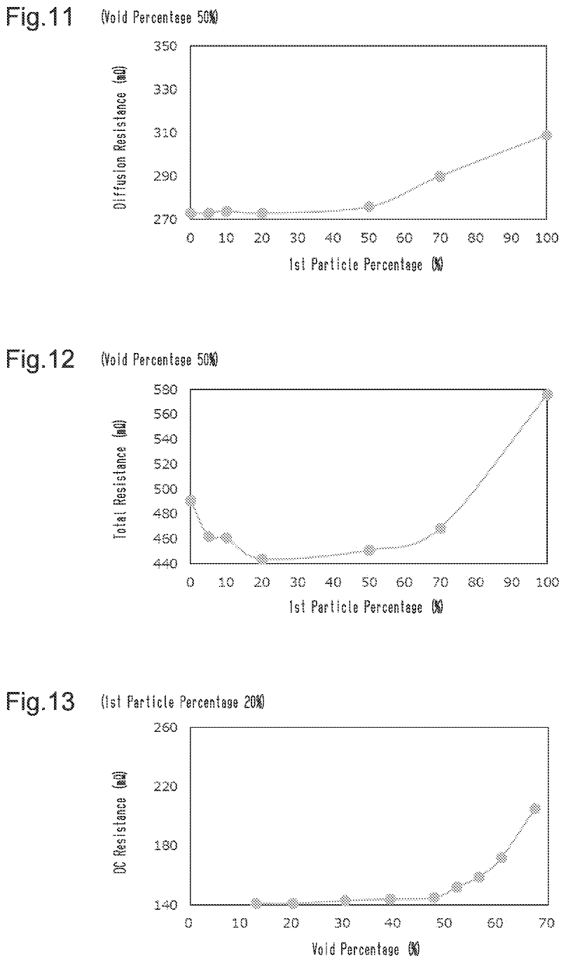

FIGS. 9 to 11 show graphs plotting the values of the DC resistance, the reaction resistance, and the diffusion resistance for examples 6 to 10 and comparative examples 3 and 4. The DC resistance increased suddenly when the first particle percentage became 70% or greater. The reaction resistance increased as the first particle percentage decreased when the first particle percentage was less than 20%. More specifically, the reaction resistance increased as the first particle percentage decreased when the first particle percentage was less than 5%, and the reaction resistance slightly increased as the first particle percentage decreased when the first particle percentage was 5% or greater and less than 20%. The diffusion resistance increased gradually when the first particle percentage was 50% or greater. The inclination of the ratio of the diffusion resistance to the increase in the first particle percentage became greater and the diffusion resistance further increased when the first particle percentage was 70% or greater.

FIG. 12 shows a graph plotting the values of the total resistance for examples 6 to 10 and comparative examples 3 and 4. The total resistance exceeded 490 mΩ when the first particle percentage was less than 5% and the first particle percentage was greater than 70% and 100% or less. The total resistance was from 461 mΩ to 469 mΩ, inclusive, and relatively low when the first particle percentage was 5% or greater and less than 20% and when the first particle percentage was greater than 50% and 70% or less. The total resistance was the lowest at 444 mΩ to 451 mΩ when the first particle percentage was 20% or greater and 50% or less.

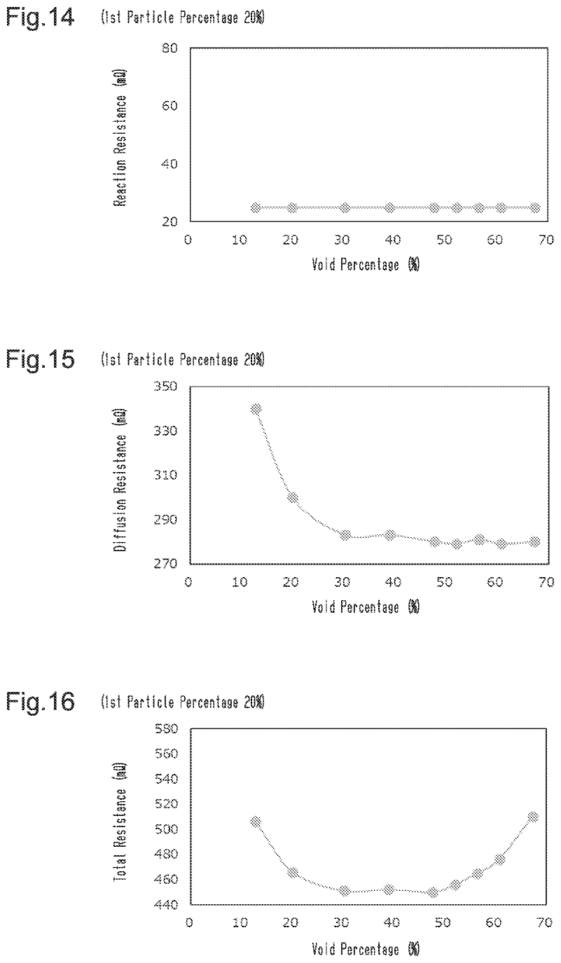

FIGS. 13 to 15 show graphs plotting the values of the DC resistance, the reaction resistance, and the diffusion resistance for examples 11 to 16 and comparative examples 5 to 7.

The DC resistance increased when the void percentage exceeded 50% and increased suddenly when the void percentage exceeded 70%. The reaction resistance was constant at 25 mΩ. The diffusion resistance increased suddenly when the void percentage became 30% or less.

FIG. 16 shows a graph plotting the values of the total resistance for examples 11 to 16 and comparative examples 5 to 7. The total resistance was the lowest when the void percentage was 30% or greater and 50% or less. The total resistance increased suddenly when the void percentage was less than 20% and when the void percentage was greater than 60%. The total resistance increased slightly when the void percentage was 20% or greater and less than 30% and the void percentage was greater than 50% and 60% or less.

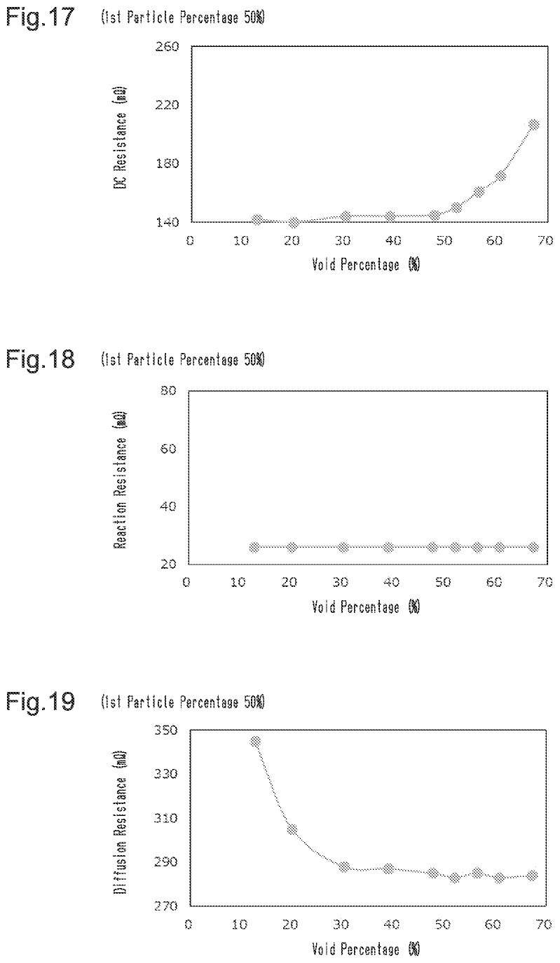

FIGS. 17 to 19 show graphs plotting the values of the DC resistance, the reaction resistance, and the diffusion resistance for examples 17 to 22 and comparative examples 8 to 10.

The DC resistance increased gradually when the void percentage was greater than 50% and 60% or less and increased suddenly when the void percentage was greater than 60%. The reaction resistance was constant at 26 mΩ. The diffusion resistance increased as the void percentage decreased when the void percentage was less than 30%. The diffusion resistance increased gradually when the void percentage was 20% or greater and less than 30% and increased suddenly when the void percentage was less than 20%.

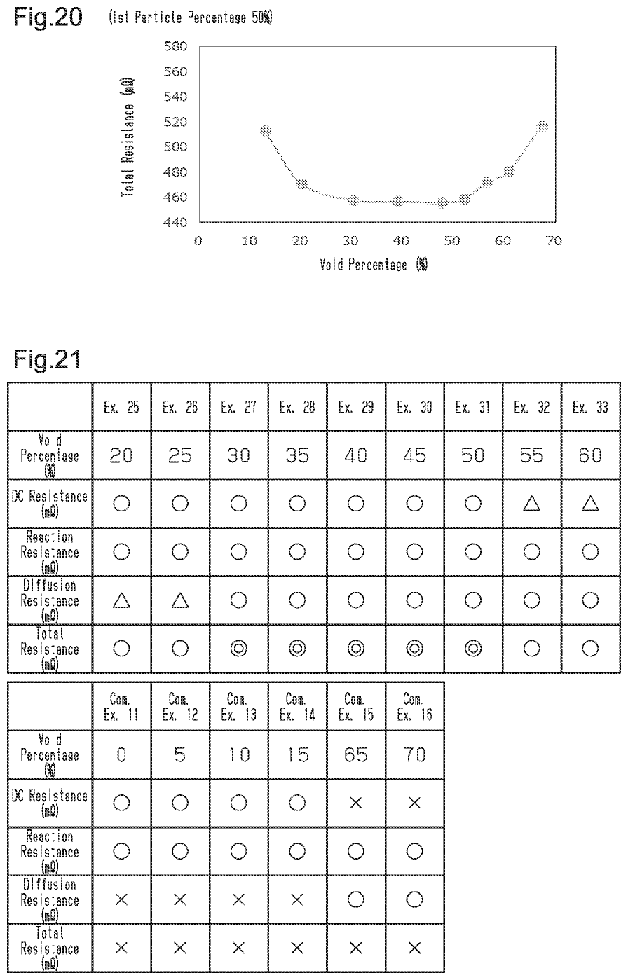

FIG. 20 is a graph showing values of the total resistance for examples 17 to 22 and comparative examples 8 to 10. The total resistance was the lowest when the void percentage was 30% or greater and 50% or less. The total resistance increased suddenly when the void percentage was less than 20% and when the void percentage was greater than 60%. The total resistance increased gradually when the void percentage was 20% or greater and less than 30% and when the void percentage was greater than 50% and 60% or less.

Examples Related to Carbon Material

The void percentage was changed and compared with each resistance component and the total resistance for examples using carbon nanotubes as the carbon material and comparative example 17 to 29 using acetylene black as the carbon material. When changing the aspect ratio of the conductive material, the void percentage of the positive electrode mixture material layer 19 has a large effect on the total resistance, and the first particle percentage has a relatively small effect on the total resistance. Thus, only the void percentage was changed.

### Examples 25 to 33

In examples 25 to 33, a lithium-ion battery 10 was formed by adjusting the void percentage in 5%-intervals from 20% to 60% and setting the first particle percentage to 20%.

### Comparative Examples 11 to 16

In comparative examples 11 to 14, the void percentage was 0%, 5%, 10%, and 15%, respectively. In comparative examples 15 and 16, the void percentage was 65% and 70%, respectively. Carbon nanotubes were used as the conductive material in the comparative examples. The lithium-ion battery 10 was formed in the same manner as in example 1.

### Comparative Examples 17 to 29

In comparative examples 17 to 29, acetylene black was used as the conductive material. The aspect ratio of acetylene black was 1:10 or less. The void percentage was adjusted in increments of 5% between 0% to 60%. Positive electrode mixture material paste that included carbon nanotubes as the conductive material had a void percentage of 70% when applied to the positive electrode collector and dried. Thus, a positive electrode sheet could not be formed when the void percentage exceeded 70%. Positive electrode mixture material paste that included acetylene black as the conductive material had a void percentage of 60% when applied to the positive electrode collector and dried. Thus, a positive electrode sheet could not be formed in the comparative example having the void percentage of 65% and the comparison example having the void percentage of 70%.

Evaluation 2

With respect to the DC resistance, an X indicates 175 mΩ or greater, a triangle indicates 155 mΩ or greater and less than 175 mg, and a circle indicates less than 155 mΩ.

With respect to the reaction resistance, an X indicates 50 mΩ or greater, a triangle indicates 30 mΩ or greater and less than 50 mΩ, and a circle indicates less than 30 mΩ.

With respect to the diffusion resistance, an X indicates 310 mΩ or greater, a triangle indicates 290 mΩ or greater and less than 310 mΩ, and a circle indicates less than 290 ma

With respect to the total resistance, an X indicates 485 mΩ or greater, a circle indicates 465 mΩ or greater and less than 485 mΩ, and a double circle indicates less than 465 mΩ.

With reference to FIG. 21, examples 25 to 33 and comparative examples 11 to 16 that use carbon nanotubes as the conductive material will now be described. The DC resistance was a circle in each of examples 25 to 31 and comparative examples 11 to 14, a triangle in each of examples 32 and 33, and an X in each of comparative examples 15 and 16.

The reaction resistance was a circle in every one of the examples and comparative examples.

The diffusion resistance was a circle in each of examples 27 to 33 and comparative examples 15 and 16, and an X in each of comparative examples 11 to 14.

The total resistance was a double circle in each of examples 27 to 31, a circle in each of examples 25, 26, 32, and 33, and an X in each of comparative examples 11 to 16.

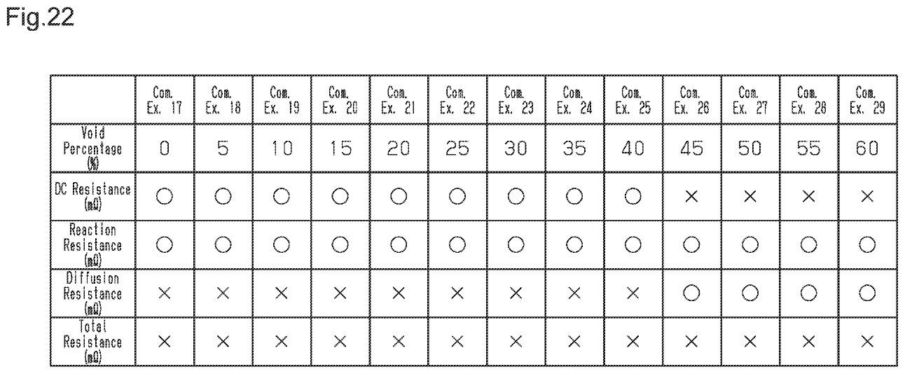

With reference to FIG. 22, comparative examples 17 to 29 that use acetylene black as the conductive material will now be described. The DC resistance was a circle in each of comparative examples 17 to 25, and an X in each of comparative examples 26 to 29 in which the void percentage was 45% or greater. When the conductive material was carbon nanotubes, the DC resistance was an X when the void percentage was 65% or greater. When the conductive material was acetylene black, the DC resistance was an X when the void percentage was 45% or greater, and the range of the void percentage that obtained a low DC resistance was narrowed.

The reaction resistance was a circle in every one of the examples and comparative examples.

The diffusion resistance was an X in each of comparative examples 17 to 25 in which the void percentage was 40% or less and a circle in each of comparative examples 26 to 29 in which the void percentage was 45% or greater. When using carbon nanotubes as the conductive material, a circle was marked when the void percentage was 30% or greater and 60% or less, and a triangle was marked even when the void percentage was less than 30%. However, when the conductive material was particulate, an X was marked even when the void percentage was 30% or greater and 40% or less. When the conductive material was carbon nanotubes, the diffusion resistance was an X when the void percentage was 15% or less. When the conductive material was acetylene black, the diffusion resistance was X when the void percentage was 40% or less, and the range of the void percentage that obtained the low diffusion resistance was narrowed.

The total resistance was an X in each of comparative example 17 to 29 that used acetylene black.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A lithium-ion battery, comprising:
a positive electrode including a positive electrode mixture material containing positive electrode active material particles and a conductive material;
a negative electrode including a negative electrode mixture material; and
an electrolyte, wherein:
the positive electrode active material particles of the positive electrode mixture material include primary particles, a first particle aggregate of the primary particles cohered into a hollow mass with a hollow portion having a diameter of less than 1 μm, and a second particle aggregate of the primary particles cohered into a hollow mass with a hollow portion having a diameter of 1 μm or greater;
when referring to the primary particles and the first particle aggregate as first particles, a percentage of a total volume of the first particles with respect to a total volume of the positive electrode active material particles is 5% or greater and 70% or less;
the positive electrode mixture material has a void percentage of 20% or greater and 60% or less; and
the conductive material has an aspect ratio of 1:10 or greater.

2. The lithium-ion battery according to claim 1, wherein the percentage of the volume of the first particles is 20% or greater and 50% or less.

3. The lithium-ion battery according to claim 1, wherein the void percentage is 30% or greater and 50% or less.

4. The lithium-ion battery according to claim 1, wherein the aspect ratio of the conductive material is 1:30 or greater.

5. The lithium-ion battery according to claim 1, wherein a content percentage of the conductive material with respect to weight of positive electrode mixture material is 0.1 wt % or greater and 5 wt % or less.

6. The lithium-ion battery according to claim 1, wherein the conductive material has an average diameter of 1 nm or greater and 100 nm or less.
